(19) United States
(12) Patent Application Publication
(10) Pub. No.: US 2013/0285865 A1
(43) Pub. Date: Oct. 31, 2013

(54) PRINTED SLOT-TYPE DIRECTIONAL ANTENNA, AND SYSTEM COMPRISING AN ARRAY OF A PLURALITY OF PRINTED SLOT-TYPE DIRECTIONAL ANTENNAS

(71) Applicants: Dominique Lo Hine Tong, Rennes (FR); Ali Louzir, Rennes (FR); Philippe Minard, Saint Medard Sur Ille (FR); Jean-Francois Pintos, Saint Blaise Du Buis (FR)

(72) Inventors: Dominique Lo Hine Tong, Rennes (FR); Ali Louzir, Rennes (FR); Philippe Minard, Saint Medard Sur Ille (FR); Jean-Francois Pintos, Saint Blaise Du Buis (FR)

(73) Assignee: Thomson Licensing

(21) Appl. No.: 13/979,466

(22) PCT Filed: Nov. 30, 2011
(86) PCT No.: PCT/FR2011/052822

§ 371 Date: Jul. 12, 2013

(30) Foreign Application Priority Data
Jan. 13, 2011 (FR) 1150272

(51) Int. Cl. H01Q 13/10

(52) U.S. Cl. CPC H01Q 13/10
USPC 343/767

(57) ABSTRACT

The present invention relates to a printed slot-type directional antenna. The invention also relates to antenna systems formed by arranging a plurality of such antennas in an array. The flared printed slot-type directional antenna includes a substrate having a floorplan, in which the slot is etched along a profile having a longitudinal axis, and a line for supplying power to the slot, and is characterized in that the substrate comprises at least one first and one second portion which are folded along an axis that is parallel to said longitudinal axis, and which form an angle A relative to one another.

The present invention relates to printed directive slot-type antennas, notably Vivaldi-type antennas. It also relates to different systems networking said printed slot-type antennas so as to realize compact multi-beam antenna systems also able to have an orthogonal dual polarization.

The increasing development of communications systems, notably wireless communication systems, requires the implementation of increasingly complex and effective devices while keeping manufacturing costs as low as possible and a minimum size. In order to meet these constraints, MIMO (multiple input multiple output) technology is increasingly used which implements a multi-antenna concept in order to improve the transmission performances both in terms of bitrate and robustness, in an environment dominated notably by interferences. These MIMO type multi-antenna transmission devices have led to the development of directive antenna solutions. There are numerous advantages of directivity. In fact, they enable interferences to be reduced, the range of wireless links to be improved, the RF power to be reduced, that is to say the complexity and cost related to dissipation. Moreover, directive antennas enable the average exposure to electromagnetic radiation to be reduced.

Furthermore, the use of directive antennas, by rejecting the interferences upstream of the receiver channel, makes it possible in a MIMO system to reduce the complexity related to the management of nonlinearities, noise and dynamics of the radio frequency channel. A solution based on directive antennas also makes it possible to simplify the processing of the digital signal notably the additional processing related to the cancellation of interfering signals in the case of a MIMO solution using non-directive antennas. However, the directive antennas are typically bulky and networking several directive antennas greatly increases this problem.

Among printed directive antennas, tapered slot-type antennas such as Vivaldi-type antennas are known. Antennas of this type have the advantage of great flexibility in terms of value of directivity. In fact, this value is fixed by the length of the profile and the width of the opening. Moreover, these antennas also have great flexibility as regards the form of the radiation pattern, the apertures in the E and H planes able to be adjusted by exploiting the form and width of the profile and the aperture of the opening. Furthermore, these antennas have a natural linear polarization, the direction of the polarization being given by the plane of the substrate on which the antenna is etched. Thus, it has already been proposed in various patent applications to use the networking of N Vivaldi-type antennas to obtain directive multi-beam antenna systems.

In international patent application n° WO2008/065311 in the name of Thomson Licensing, it has been proposed a multi-sector antenna constituted by networking several Vivaldi antennas realized on substrates arranged vertically and spaced at an angle of 360° from one another. These antennas are associated with an excitation system which can be in a horizontal plane supporting said substrates. This structure makes it possible to reduce the final diameter of the antenna system at the expense of the height and offers an additional degree of flexibility for the form factor of the antenna system.

It has also been proposed in French patent application n° 0958692 filed in the name of Thomson Licensing to combine two structures such as described in the previous application to attain an orthogonal dual-polarization antenna system. By associating it with a beam-switching matrix enabling the selection of a certain number of beams corresponding, for example, to the order of the MIMO system, this antenna solution can be used as the basis for a MIMO system, with orthogonal dual-polarization directive antennas.

However, despite this spatial optimization, the bulkiness of antenna systems described above remains relatively significant. The present invention therefore seeks to reduce the bulkiness and the volume of the systems described above by a factor approximately equal to two.

Thus, the purpose of the present invention is a printed directive tapered slot-type antenna comprising a substrate equipped with a ground plane in which is etched the slot according to a profile having a longitudinal axis and a feeder line for the slot, characterized in that the substrate comprises at least a first and a second part folded according to an axis parallel to said axis and forming an angle A with respect to one another, a first part of the profile of the slot being etched in the first part of the substrate and a second part of the profile of the slot being etched in the second part of the substrate.

Preferably, the angle is an angle of 90°, that is, the two substrate parts are perpendicular with respect to one another.

According to another characteristic of the present invention, the ground plane is realized on a lower or external face of said first and second parts of the substrate.

The present invention also relates to a printed directive tapered slot-type antenna system comprising a first substrate and N second substrates, the N second substrates forming an angle A with respect to the first substrate, the first and the N second substrates delimiting N sectors, characterized in that, in at least one of the sectors, is realized a directive antenna as described above, the first part being formed by the first substrate and the second part being formed by one of the second substrates.

The present invention also relates to a printed directive tapered slot-type antenna system comprising a first substrate, a third substrate and N second substrates, the N second substrates forming an angle A with respect to the first substrate and an angle B with respect to the third substrate, the first substrate, the third substrate and the N second substrates delimiting N sectors, characterized in that in at least one of the sectors of even or odd rank is realized a directive antenna as described above, the first part being formed by the first substrate and the second part being formed by one of the second substrates and in at least one of the sectors of odd or even rank is realized a directive antenna as described above, the first part being formed by the third substrate and the second part being formed by one of the second substrates.

According to a preferred embodiment, the angles A and B are equal to 90° so that the first and third substrates are perpendicular to the N second substrates.

According to another embodiment, the invention relates to a printed directive tapered slot-type antenna system comprising a first substrate, a third substrate, the first and third substrates being of polygonal shape, and N second substrates, N corresponding to the number of sides of the polygon, the N second substrates connecting the first substrate to the third substrate, characterized in that, at at least one of the connections between the first substrate or the third substrate and one of the second substrates, is realized a directive antenna as described above.

Other characteristics and advantages of the present invention will emerge upon reading the following detailed description of various embodiments, this description being made with reference to the drawings attached in the appendix, in which:

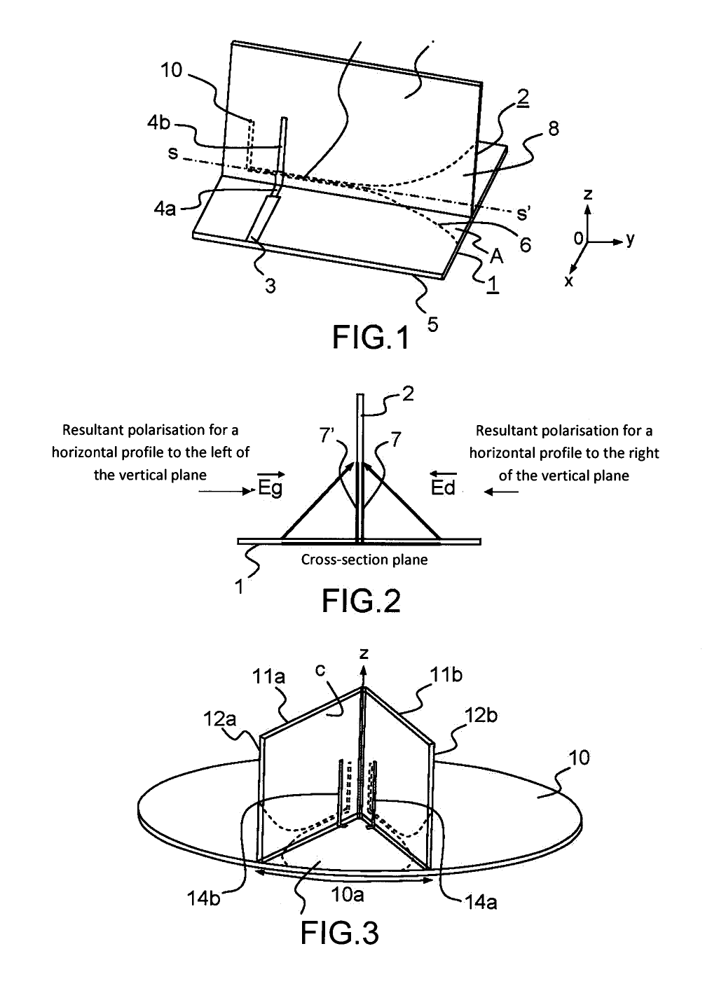

FIG. 1 is a diagrammatic perspective view of a printed antenna in accordance with the present invention.

FIG. 2 is a cross-section giving the polarization of the electric field according to the position of the horizontal profile with respect to the vertical profile for antennas in accordance with the principle of the present invention.

FIG. 3 is a perspective view showing a system with two antennas such as the antennas in FIG. 1 networked in accordance with the principle of the present invention.

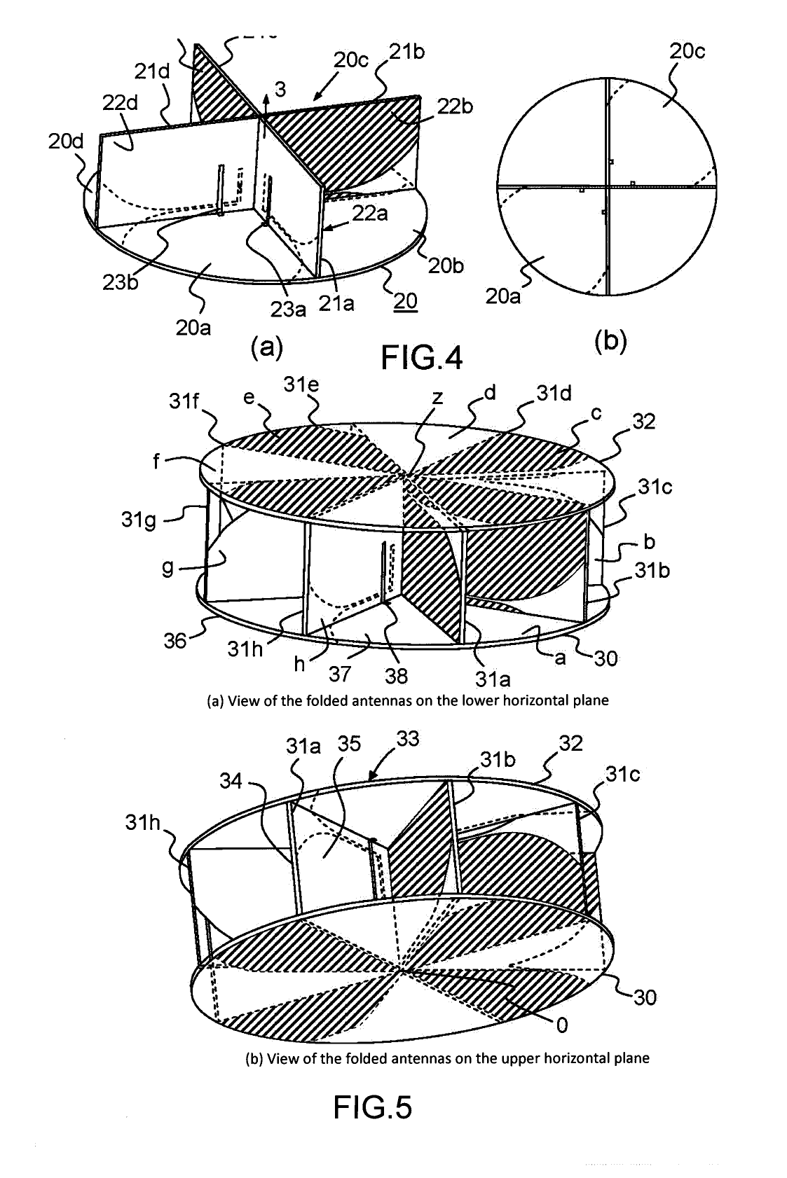

FIGS. 4a and 4b are respectively a perspective representation of a system with four antennas such as the antennas shown in FIG. 1 networked in accordance with the present invention and a top plan view.

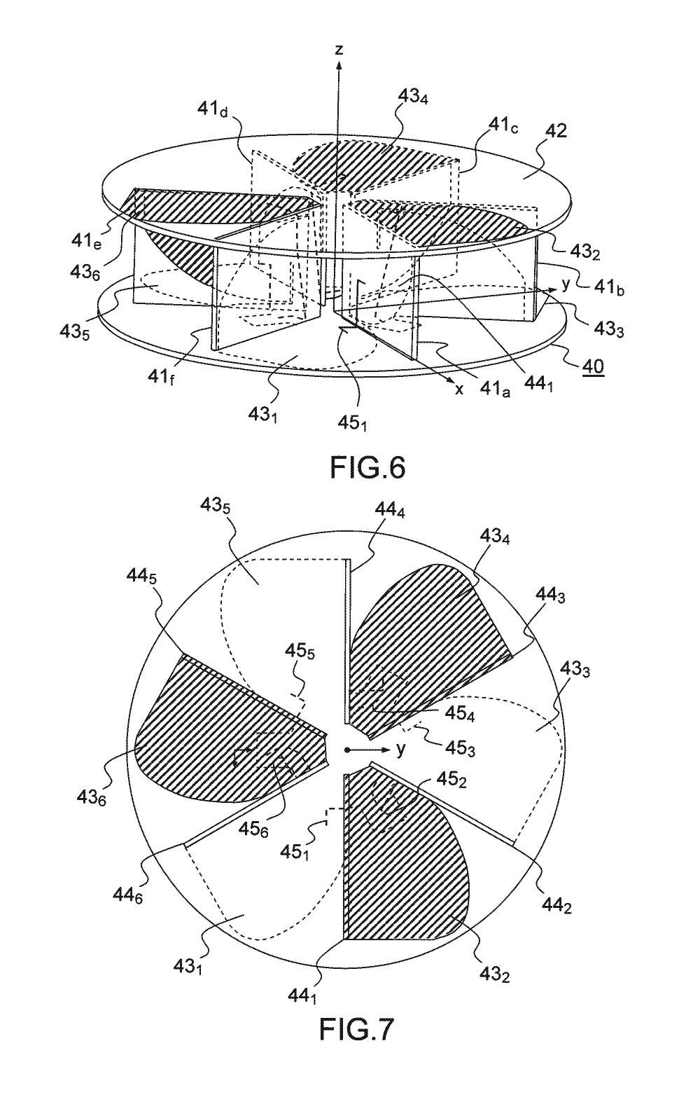

FIGS. 5a and 5b are two perspective views of a system with eight antennas such as the antennas shown in FIG. 1 networked in accordance with the present invention, FIG. 5a being a view of the antennas folded on the lower horizontal plane and FIG. 5b being a view of the antennas folded on the upper horizontal plane.

FIG. 6 is a perspective view of a system with six antennas in accordance with the present invention.

FIG. 7 is a top view of the antenna system of FIG. 6.

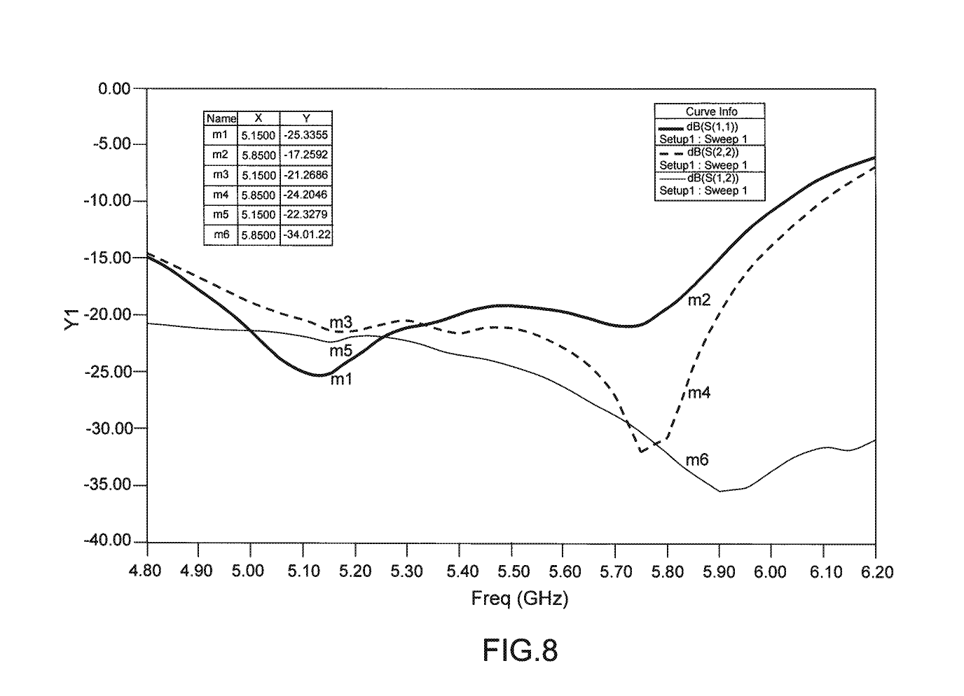

FIG. 8 shows curves giving the adaptation and isolation as a function of the frequency of the system shown in FIGS. 6 and 7.

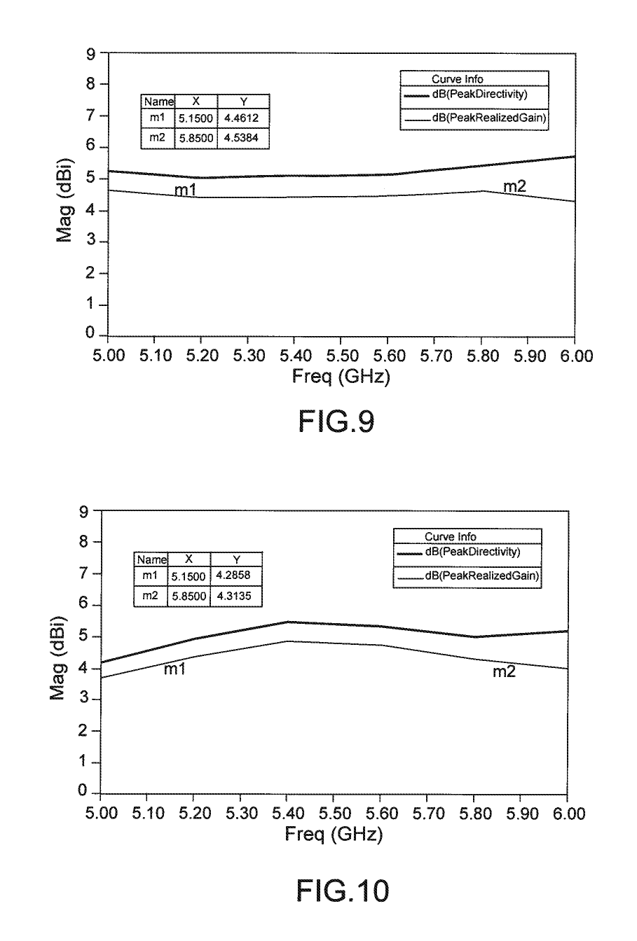

FIGS. 9 and 10 respectively show as a function of frequency, the gain and directivity of the antennas realized on the first substrate or on the third substrate, for the embodiment of FIGS. 6 and 7.

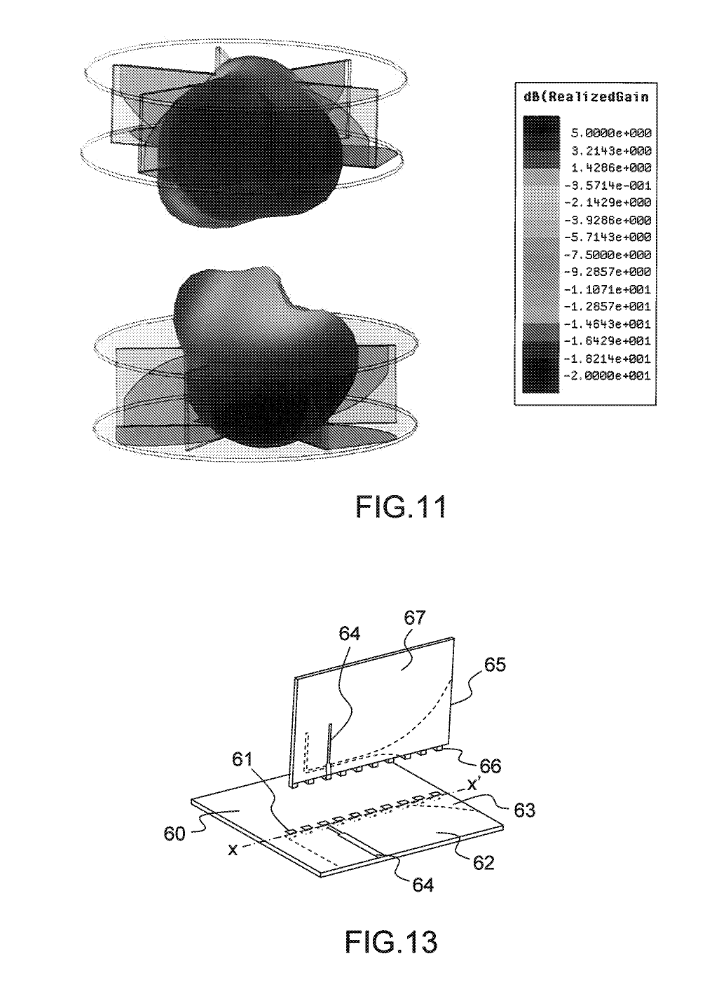

FIG. 11 shows the radiation pattern with respect to the upper plane and the lower plane for the embodiment of FIGS. 6 and 7.

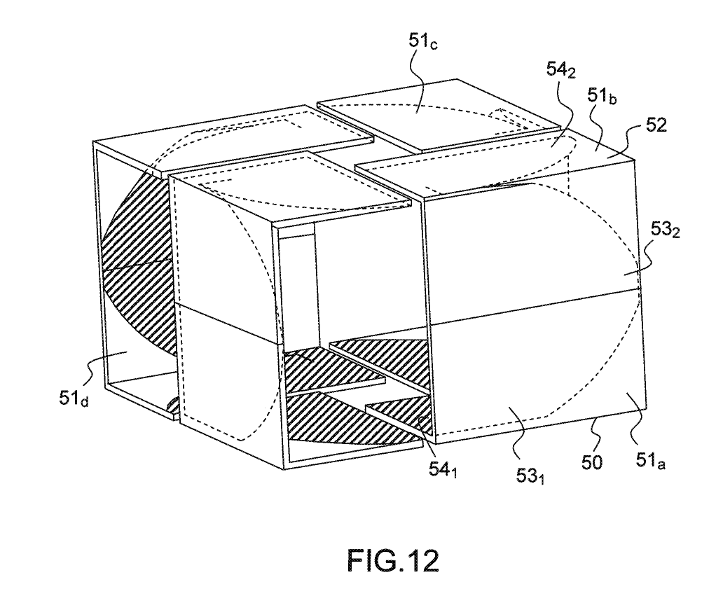

FIG. 12 shows another embodiment of a system with eight antennas arranged according to four sectors.

FIG. 12 shows diagrammatically a practical embodiment of the antenna of FIG. 1.

To simplify the description, the same elements have the same references as the figures relating to the same embodiment.

With reference to FIG. 1, a particular embodiment of a printed directive tapered slot-type antenna in accordance with the present invention will first be described. The slot antenna described in this embodiment is a Vivaldi-type antenna. However, it is clear to those skilled in the art that the present invention can be applied to other types of tapered slot antennas.

As shown in FIG. 1, the antenna in accordance with the present invention comprises an element forming a substrate constituted of a first substrate part 1 and a second substrate part 2 which, in the embodiment shown, are arranged perpendicularly to one another. More generally, the two substrate parts 1 and 2 can be folded according to an axis O Y and form between them an angle A different from 90°. In general, the two substrate parts are formed by independent substrates and in the description substrate part and substrate have the same meaning.

As shown in FIG. 1, on the upper face of the first part of substrate 1 is printed a microstrip excitation line 3 which is extended by a first part of the adaptation line 4a enabling the slot antenna to be fed by electromagnetic coupling, notably according to the Knorr principle. On the lower face of the first part 1 of the substrate is realized a ground plane 5 in which is etched a part 6 of the profile of the slot antenna. Moreover, on the rear face of the second substrate part 2 is etched in the ground plane 7 the second part 8 of the profile of the antenna which is extended by a slot 9 terminating in a short circuit 10. On the front face of this second substrate part 2 is printed the second part 4b of the adaptation line cutting the slot 9 at a length λf/4 from its short-circuited end and terminating for example in a circuit open on a length of λm/4(λf and λm being respectively the guided wavelengths at the operating frequency of the slot and the microstrip line). In this embodiment as mentioned above, the Vivaldi-type slot antenna is fed by electromagnetic coupling according to the known Knorr principle. In order to ensure correct operation of the device, the rear face 5 of the first substrate part 1 and the rear face 7 of the second substrate part 2 are electrically connected. Moreover, as shown in FIG. 1, the folding line O Y between the first substrate part 1 and the second substrate part 2 is not realized according to the axis ss′ of the slot 9 of the Vivaldi antenna but parallel and in proximity to said axis.

It is known to those skilled in the art that a planar slot-type antenna, notably a Vivaldi antenna, naturally has a linear polarization, the direction of the polarization being given by the antenna plane. Thus according to this new concept where the antenna is folded along two planes, most often orthogonal as shown in FIG. 1, the result is an oblique polarization at around 45° approximately along a plane connecting the two ends of the opening of the antenna and collinear with the Y axis, axis of longitudinal symmetry. Thus, as shown in FIG. 2 according to whether the horizontal profile of the antenna is realized on one side 7 or the other 7′ of the second substrate part 2, the result is an oblique linear polarization at approximately ±45° along two orthogonal planes. This is shown in FIG. 2 by a polarization \vec{Eg} for a profile to the left of the vertical plane and a polarization \vec{Ed} for a profile to the right of the vertical plane.

A description will now be given, with reference to FIGS. 3, 4 and 5, of several embodiments of multi-sector antenna systems based on the use of directive printed Vivaldi-type antennas such as shown in FIG. 1.

Thus, in FIG. 3, is shown a system constituted by two folded Vivaldi-type antennas. More specifically, this system comprises a first horizontal substrate 10 and two second vertical substrates 11a and 11b, interconnected according to a common axis OZ and making an angle C of 45° between them. On the external surface of substrates 11a and 11b are realized ground planes 12a and 12b in which is etched a first part of the Vivaldi-type antenna as shown in FIG. 1. The second part of the Vivaldi-type antenna is etched in the ground plane realized on the upper face of the first horizontal substrate 10 in sector 10a. Moreover, feeder lines 14a and 14b are realized on the internal face of two second substrates 11a and 11b and are extended on the upper face of the first substrate 10. As explained with reference to FIG. 2, in this case each antenna benefits from a polarization in a different direction. One of the antennas has a horizontal profile to the right with respect to the vertical substrate 11a and the other has a horizontal profile to the left with respect to the vertical substrate 11b. The result is therefore an orthogonality of polarizations, which enables a better decorrelation of antennas.

A description will now be given, with reference to FIG. 4, of another embodiment of a system comprising four Vivaldi-type antennas such as shown in FIG. 1. In this case, the system comprises a first horizontal substrate 20 to which are fixed perpendicularly four second substrates 21a, 21b, 21c and 21d interconnected according to a common axis OZ. These four second substrates delimit four sectors 20a, 20b, 20c and 20d on the first substrate. As shown in FIG. 4, folded Vivaldi-type antennas, as in the embodiment of FIG. 1, were realized on each second substrate (21a, 21b, 21c, 21d) and the horizontal substrate (20) in the manner shown in FIG. 3. More specifically, the antennas are associated in pairs in such a way that a part of the antennas is etched in sectors 20a and 20c of the first substrate as shown in FIG. 4b. The second antenna parts are etched on the surfaces of the second substrates external to these sectors, that is, in the metallizations 22a, 22b, 22c and 22d realized on the second substrates 21a, 21b, 21c and 21d. Feeder lines 23a and 23b and the lines not shown for sector 20c are realized on the faces internal to the sectors of the second substrates concerned.

A description will now be given, with reference to FIGS. 5a and 5b, of another embodiment of an antenna system in accordance with the present invention enabling a better isolation between antennas to be obtained. In this case, as shown in the figures, a third substrate is used parallel to the first substrate. More specifically, in FIGS. 5a and 5b an antenna system with eight antennas is shown comprising a first horizontal substrate 30 on which are mounted perpendicularly eight second substrates 31a, 31b, 31c, 31d, 31e, 31f, 31g and 31h interconnected according to an axis OZ and a third horizontal substrate 32 parallel to the first substrate 30. This set determines eight reference sectors a, b, c, d, e, f, g and h. It is clear to those skilled in the art that substrates 30 and 32 could be realized without being parallel, the N second substrates making an angle A with respect to the first substrate 30 and an angle B with respect to the third substrate 32. As shown clearly in FIGS. 5a and 5b, in this embodiment, printed directive Vivaldi-type antennas such as shown in FIG. 1 were used. The antennas are realized respectively between the first substrate and one of the second substrates for the sectors of even rank, for example, and between the third substrate and one of the second substrates for the sectors of odd rank, or vice versa. Thus, if sector a delimited by second substrates 31a and 31b in FIG. 5b is examined more particularly, the printed directive antenna is realized in the ground plane 33 of the third substrate 32 and in the ground plane 34 of second substrate 31a and is fed by feeder line 35, while, as shown in FIG. 5a, for sector h delimited by second substrates 31a and 31h, the printed directive antenna is etched in the ground plane 37 of substrate 30 and in the ground plane 36 of second substrate 31h and is fed by line 38. Thus the present invention enables a multi-beam antenna system to be obtained which is much more compact in height than the systems of the prior art described notably in the patents mentioned above. Moreover, the arrangement of the antenna profiles is realized so as to conserve the orthogonality of the polarizations of the antennas, the excitations of the antennas being performed from the same side of the vertical substrates as shown in the figures.

A description will now be given, with reference to FIGS. 6 to 11, of another embodiment of a system with six antennas in accordance with the present invention. This system was realized in order to be simulated using the 3D electromagnetic solver by the ANSYS/HFSS finite element method.

As shown in FIG. 6, the system with six antennas comprises a first substrate 40, six second substrates 41a, 41b, 41c, 41d, 41e and 41f and a third substrate 42, substrates 40 and 42 being parallel to one another and the six second substrates being interconnected according to an axis OZ and perpendicular to both the first and third substrates.

As shown clearly in FIGS. 6 and 7, the six antennas are distributed alternately on horizontal planes 40 and 42 and on the vertical planes around the axis OZ and the angular step between two vertical planes formed by the second substrates is 60°. More specifically, a Vivaldi antenna in accordance with the present invention is therefore realized in each odd sector by using the first substrate 40 and for each even sector by using the second substrate 42. We therefore have a first antenna etched in the ground plane 43.1 of the first substrate 40 and the ground plane 44.1 of second substrate 41a and fed by the feeder line 45.1. Moreover, the second antenna is realized by etching ground plane 43.2 on the third substrate 42 and ground plane 44.2 on second substrate 41b then alternately for ground plane 43.3 of the first substrate 40 and ground plane 44.3 on second substrate 41c, 43.4 of the third substrate 42 and ground plane 44.4 on second substrate 41d, 43.5 of the first substrate 40 and ground plane 44.5 on second substrate 41e and 43.6 of the third substrate 42 and ground plane 44.6 on second substrate 41f. In this case the set of antennas are fed separately as shown by feeder lines 45.1, 45.2, 45.3, 45.4, 45.5 and 45.6 in FIG. 7.

The system described with reference to FIGS. 6 and 7 was simulated by using for the different substrates 40, 41a to 41f and 42 a material known as FR4 of thickness 1 millimeter. Substrates 40 and 42 are substrates of circular form of diameter 88 millimeters and the six second substrates 41a to 41f have a rectangular form with a height of 22 millimeters and a width of 33 millimeters.

The results of the electromagnetic simulation are shown in FIGS. 8 to 11. FIG. 8 shows the adaptation and isolation curves. An adaptation is therefore observed of more than 15 dB in the 802.11a WiFi band, namely the band comprised between 5.15-5.85 GHz. An isolation is also observed between two contiguous antennas of more than 20 dB. FIGS. 9 and 10 show the gain and the directivity of the antennas respectively realized on the first substrate 40 FIG. 9 or on the third substrate 42 FIG. 10. The curves therefore show a directivity greater than 5 dBi and a gain greater than 4 dBi whatever the antenna type. FIG. 11 shows the radiation pattern respectively of an antenna realized with the first substrate and of an antenna realized with the third substrate, a field maximum is therefore observed on two oblique planes oriented 45° with respect to the two planes of the antennas formed from the first substrate 40 or from the third substrate 42.

A description will now be given, with reference to FIG. 12, of another embodiment of an antenna system in accordance with the present invention.

In this case, the first substrate 50 and the third substrate 52 parallel to the first substrate are both constituted by rectangles and the second substrates 51a, 51b, 51c and 51d form the faces of a rectangular parallelepiped. As shown in FIG. 12, in order to realize eight antennas, the edges of the parallelepiped are used in this particular embodiment. More specifically, a first antenna is realized by etching ground plane 53 provided on face 51a of one of the second substrates and ground plane 54 provided on the first substrate 50, while a second antenna is realized by etching ground plane 53.2 provided on the upper part of second substrate 51a and ground plane 54.2 provided on the third substrate 52. A set of two antennas of this type is realized on each second substrate 51b, 51c and 51d as shown in FIG. 12, therefore giving an antenna system with four sectors and with eight printed directive Vivaldi-type antennas, each pair of antennas in a given sector having orthogonal polarizations.

With reference to FIG. 13, a practical embodiment of a printed directive tapered slot-type antenna such as shown in FIG. 1 will now be described succinctly. In this case, the first substrate part or first substrate 60 comprises along the axis x x′ forming a fold, a certain number of metallized holes 62. This substrate part 60 is equipped in a known manner with a metallization 62 in which is realized the profile 63 of the Vivaldi-type antenna part. On the upper face of part 60 is also metallized a feeder line 64 such as described with reference to FIG. 1. As shown in FIG. 13, the second substrate part or second substrate 65 is equipped with a certain number of metallized pins 66, the number and the form of the pins 66 corresponding to the number and the form of the holes 61. Moreover, on this second part 65 is realized the other part of the profile of the Vivaldi-type antenna etched in a metallization 67. The other face of part 65 receives the extension of the feeder line 64 as described with reference to FIG. 1. In this case, the folded antenna structure is easily obtained by inserting part 65 equipped with pins 66 into the metallized holes 62 of part 60.

1. A printed directive tapered slot-type antenna comprising a substrate equipped with a ground hplane in which is etched a slot according to a profile having a longitudinal axis and a feeder line for the slot, wherein the substrate comprises at least a first and a second part folded according to an axis parallel to said longitudinal axis and forming an angle A with respect to one another, a first part of the profile of the slot being etched in the first substrate part and a second part of the profile of the slot being etched in the second part of the substrate.

2. The antenna according to claim 1, wherein the angle A is an angle of 90°.

3. The antenna according to claim 1, wherein the feeder line is a microstrip technology line realized on the face of the substrate opposite the face receiving the slot.

4. The antenna according to claim 1, wherein the ground plane is realized on a lower or external face of said first and second substrate parts.

5. A printed directive tapered slot-type antenna system comprising a first substrate and N second substrates, the N second substrates forming an angle A with respect to the first substrate, the first substrate and the N second substrates delimiting N sectors, wherein, in at least one of the sectors, is realized a directive antenna according to claim 1, the first part being formed by the first substrate and the second part being formed by one of the second substrates.

6. The system according to claim 5, wherein a directive antenna is realized in each sector of the same rank, even or odd.

7. A printed directive tapered slot-type antenna system comprising a first substrate a third substrate and N second substrates the N second substrates forming an angle A with respect to the first substrate and an angle B with respect to the third substrate, the first substrate, the third substrate and the N second substrates delimiting N sectors, wherein, in at least one of the sectors of even or odd rank is realized a directive antenna according to claim 1, the first part being formed by the first substrate and the second part being formed by one of the second substrates and in at least one of the sectors of odd or even rank is realized a directive antenna according to claim 1, the first part being formed by the third substrate and the second part being formed by one of the other second substrates.

8. The system according to claim 7, wherein the angle A and the angle B are equal to 90°.

9. A printed directive tapered slot-type antenna system comprising a first substrate a third substrate the first and third substrates being of polygonal shape, and N second substrates N corresponding to the number of sides of the polygon, the N second substrates connecting the first substrate to the third substrate, wherein, at at least one of the connections between the first substrate or the third substrate and one of the second substrates, is realized a directive antenna according to claim 1.
